(19) United States
(12) Patent Application Publication
(10) Pub. No.: US 2019/0296389 A1
(43) Pub. Date: Sep. 26, 2019

(54) LITHIUM-ION RECHARGEABLE BATTERY, BATTERY STRUCTURE OF LITHIUM-ION RECHARGEABLE BATTERY AND METHOD FOR PRODUCING LITHIUM-ION RECHARGEABLE BATTERY

(71) Applicants: SHOWA DENKO K.K., Tokyo (JP); SHOWA DENKO PACKGING CO., LTD., Isehara-shi, Kanagawa (JP)

(72) Inventors: Akira SAKAWAKI, Ichihara-shi, Chiba (JP); Takaki YASUDA, Ichihara-shi, Chiba (JP); Koji MINAMITANI, Isehara-shi, Kanagawa (JP)

(73) Assignees: SHOWA DENKO K.K., Tokyo (JP); SHOWA DENKO PACKGING CO., LTD., Isehara-shi, Kanagawa (JP)

(21) Appl. No.: 16/465,241

(22) PCT Filed: Nov. 1, 2017
(86) PCT No.: PCT/JP2017/039574

§ 371 Date: May 30, 2019

(30) Foreign Application Priority Data
Dec. 14, 2016 (JP) 2016-242378
May 11, 2017 (JP) 2017-094349

(51) Int. Cl. H01M 10/0525; H01M 10/0585; H01M 10/0562; H01M 2/02; H01M 2/06; H01M 2/26

(52) U.S. Cl. CPC H01M 10/0525; H01M 10/0585; H01M 2/26; H01M 2/0285; H01M 2/06; H01M 10/0562

(57) ABSTRACT

A lithium-ion rechargeable battery (1) includes: a battery unit (50) including a metal substrate (5); a first battery part (10) formed on a front surface of the substrate (5) and a second battery part (20) formed on a back surface thereof; and a shell (30) that houses the first battery part (10) and the second battery part (20) therein. In the shell (30), a first metal layer (313) and a second metal layer (323) are connected to a first negative electrode collector layer (14) of the first battery part (10) and a second negative electrode collector layer (24) of the second battery part (20), respectively. Further, by connecting the first metal layer (313) and the second metal layer (323), the first battery part (10) and the second battery part (20) are connected in parallel within the shell (30).

### TECHNICAL FIELD

The present invention relates to a lithium-ion rechargeable battery, a battery structure of the lithium-ion rechargeable battery and a method for producing the lithium-ion rechargeable battery.

### BACKGROUND ART

A lithium-ion rechargeable battery is known, which is provided with: a battery part including a positive electrode containing a positive-electrode active material, a negative electrode containing a negative-electrode active material, and an electrolyte having lithium-ion conductivity and interposed between the positive electrode and the negative electrode; and a shell that houses the battery part inside thereof to seal the battery part against outside air or the like.

The shell of the lithium-ion rechargeable battery is required to have high barrier properties against gases, liquids and solids. In Patent Document 1, it is described that a shell is configured by using a laminated shell material formed by laminating a metallic foil layer and a thermo-adhesive resin layer and by thermally adhering thermo-adhesive films to each other in a state where a battery part is housed inside the laminated shell material.

Moreover, as the electrolyte constituting the battery part, an organic electrolytic solution or the like has been conventionally used. In contrast thereto, in Patent Document 2, it is described that a solid electrolyte made of an inorganic material is used as the electrolyte, and all of the negative electrode, the solid electrolyte and the positive electrode are configured with thin films.

### CITATION LIST

### Patent Literature

Patent Document 1: Japanese Patent Application Laid-Open Publication No. 2016-129091

Patent Document 2: Japanese Patent Application Laid-Open Publication No. 2013-73846

### SUMMARY OF INVENTION

### Technical Problem

Here, when a lithium-ion battery was configured by using a battery part of a thin-film type and a shell (housing portion) to house the battery part inside thereof, for obtaining a larger capacity, it was necessary to connect plural lithium-ion batteries in parallel by use of connection lines or the like.

An object of the present invention is to increase a capacity of a thin-film type lithium-ion rechargeable battery including a solid electrolyte with a simple configuration.

### Solution to Problem

A lithium-ion rechargeable battery according to the present invention includes: a substrate having conductivity; a front surface battery part including a front surface first polarity layer laminated on a front surface side of the substrate to occlude and release a lithium ion with a first polarity, a front surface solid electrolyte layer laminated on the front surface first polarity layer and including an inorganic solid electrolyte having lithium-ion conductivity, and a front surface second polarity layer laminated on the front surface solid electrolyte layer to occlude and release a lithium ion with a second polarity, which is opposite to the first polarity; a back surface battery part including a back surface first polarity layer laminated on a back surface side of the substrate to occlude and release a lithium ion with the first polarity, a back surface solid electrolyte layer laminated on the back surface first polarity layer and including an inorganic solid electrolyte having lithium-ion conductivity, and a back surface second polarity layer laminated on the back surface solid electrolyte layer to occlude and release a lithium ion with the second polarity; and a housing portion including a metal layer and a resin layer laminated on the metal layer to form an exposed portion where a part of the metal layer is exposed, and housing the front surface battery portion and the back surface battery portion inside thereof, the metal layer being electrically connected to the front surface second polarity layer and the back surface second polarity layer at the exposed portion.

In such a lithium-ion rechargeable battery, the housing portion includes: a first laminated film including a first metal layer as the metal layer and a first resin layer as the resin layer laminated on the first metal layer to form a first exposed portion, where a part of the first metal layer is exposed, on one surface of the first metal layer, the front surface second polarity layer being electrically connected to the first metal layer exposed at the first exposed portion; and a second laminated film including a second metal layer as the metal layer and a second resin layer as the resin layer laminated on the second metal layer to form a second exposed portion, where a part of the second metal layer is exposed, on one surface of the second metal layer, the back surface second polarity layer being electrically connected to the second metal layer exposed at the second exposed portion, wherein the first metal layer exposed at the first exposed portion and the second metal layer exposed at the second exposed portion are electrically connected, and the front surface battery portion and the back surface battery portion are sealed between the first laminated film and the second laminated film.

Moreover, the substrate is configured with stainless steel and the metal layer is configured with aluminum.

Further, the front surface second polarity layer provided to the front surface battery part and the first metal layer exposed at the first exposed portion of the first laminated film are in direct contact, and the back surface second polarity layer provided to the back surface battery part and the second metal layer exposed at the second exposed portion of the second laminated film are in direct contact.

Moreover, from another standpoint, a battery structure of a lithium-ion rechargeable battery according to the present invention includes: a substrate having conductivity; a front surface battery part including a front surface first polarity layer laminated on a front surface side of the substrate to occlude and release a lithium ion with a first polarity, a front surface solid electrolyte layer laminated on the front surface first polarity layer and including an inorganic solid electrolyte having lithium-ion conductivity, and a front surface second polarity layer laminated on the front surface solid electrolyte layer to occlude and release a lithium ion with a second polarity, which is opposite to the first polarity; and a back surface battery part including a back surface first polarity layer laminated on a back surface side of the substrate to occlude and release a lithium ion with the first polarity, a back surface solid electrolyte layer laminated on the back surface first polarity layer and including an inorganic solid electrolyte having lithium-ion conductivity, and a back surface second polarity layer laminated on the back surface solid electrolyte layer to occlude and release a lithium ion with the second polarity.

In such a battery structure of a lithium-ion rechargeable battery, the front surface first polarity layer and the back surface first polarity layer are configured with a same material, the front surface solid electrolyte layer and the back surface solid electrolyte layer are configured with a same material, and the front surface second polarity layer and the back surface second polarity layer are configured with a same material.

Moreover, there is further provided a connection member that electrically connects the front surface second polarity layer of the front surface battery portion and the back surface second polarity layer of the back surface battery portion.

Further, from another standpoint, a method for producing a lithium-ion rechargeable battery according to the present invention includes: a process of depositing, on a front surface of a substrate, a front surface first polarity layer that occludes and releases a lithium ion with a first polarity and depositing, on a back surface of the substrate, a back surface first polarity layer that occludes and releases a lithium ion with the first polarity; a process of depositing, on the front surface first polarity layer, a front surface solid electrolyte layer that contains an inorganic solid electrolyte having lithium-ion conductivity and depositing, on the back surface first polarity layer, a back surface solid electrolyte layer that contains an inorganic solid electrolyte having lithium-ion conductivity; and a process of depositing, on the front surface solid electrolyte layer, a front surface second polarity layer that occludes and releases a lithium ion with a second polarity, which is opposite to the first polarity, and depositing, on the back surface solid electrolyte layer, a back surface second polarity layer that occludes and releases a lithium ion with the second polarity.

### Advantageous Effects of Invention

According to the present invention, it is possible to increase a capacity of a thin-film type lithium-ion rechargeable battery including a solid electrolyte with a simple configuration.

### BRIEF DESCRIPTION OF DRAWINGS

FIGS. 1A and 1B are diagrams for illustrating an overall configuration of a lithium-ion rechargeable battery to which an exemplary embodiment is applied;

FIG. 2 is a II-II cross-sectional view of FIG. 1A;

FIG. 3 is a III-III cross-sectional view of FIG. 1A;

FIG. 4 is a IV-IV cross-sectional view of FIG. 1A;

FIG. 5 is a V-V cross-sectional view of FIG. 1A;

FIGS. 6A and 6B are perspective views of a battery unit;

FIGS. 7A and 7B are perspective views of a first laminated film;

FIGS. 8A and 8B are perspective views of a second laminated film;

FIG. 9 is a flowchart for illustrating a method of producing the lithium-ion rechargeable battery;

FIG. 10 is a diagram for illustrating a modified example of the exemplary embodiment, which is a IV-IV cross-sectional view of FIG. 1A; and

FIGS. 11A and 11B are perspective views of a battery unit in the modified example of the exemplary embodiment.

### DESCRIPTION OF EMBODIMENTS

Hereinafter, an exemplary embodiment according to the present invention will be described in detail with reference to attached drawings. Note that, the size, thickness or the like of each component in the drawings referenced in the following description will differ from the actual dimension in some cases.

### [Configuration of Lithium-Ion Rechargeable Battery]

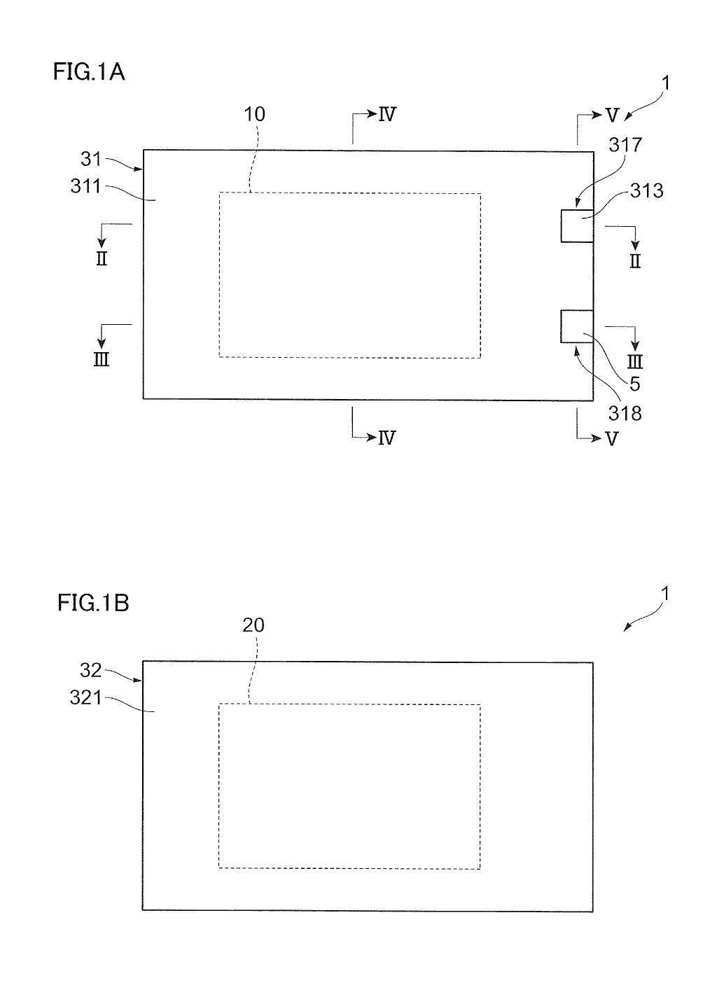

FIGS. 1A and 1B are diagrams for illustrating an overall configuration of a lithium-ion rechargeable battery 1 to which Exemplary embodiment 1 is applied. Here, FIG. 1A is a diagram in which the lithium-ion rechargeable battery 1 is viewed from the front (front surface), and FIG. 1B is a diagram in which the lithium-ion rechargeable battery 1 is viewed from the back (back surface).

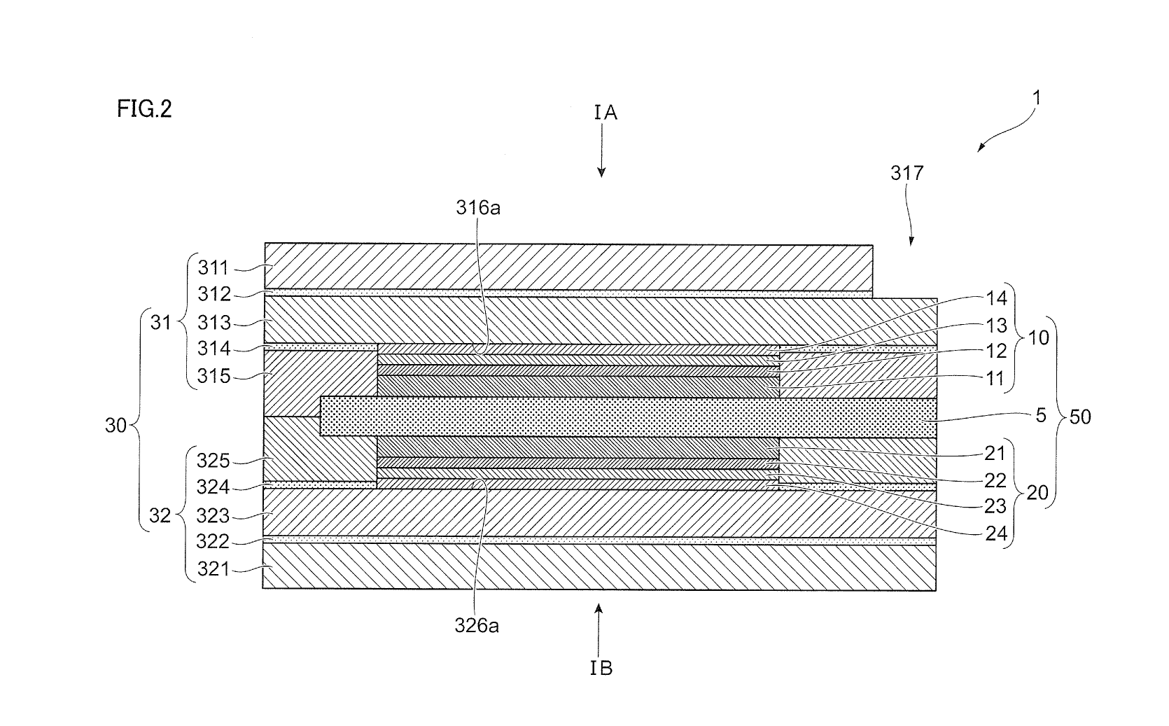

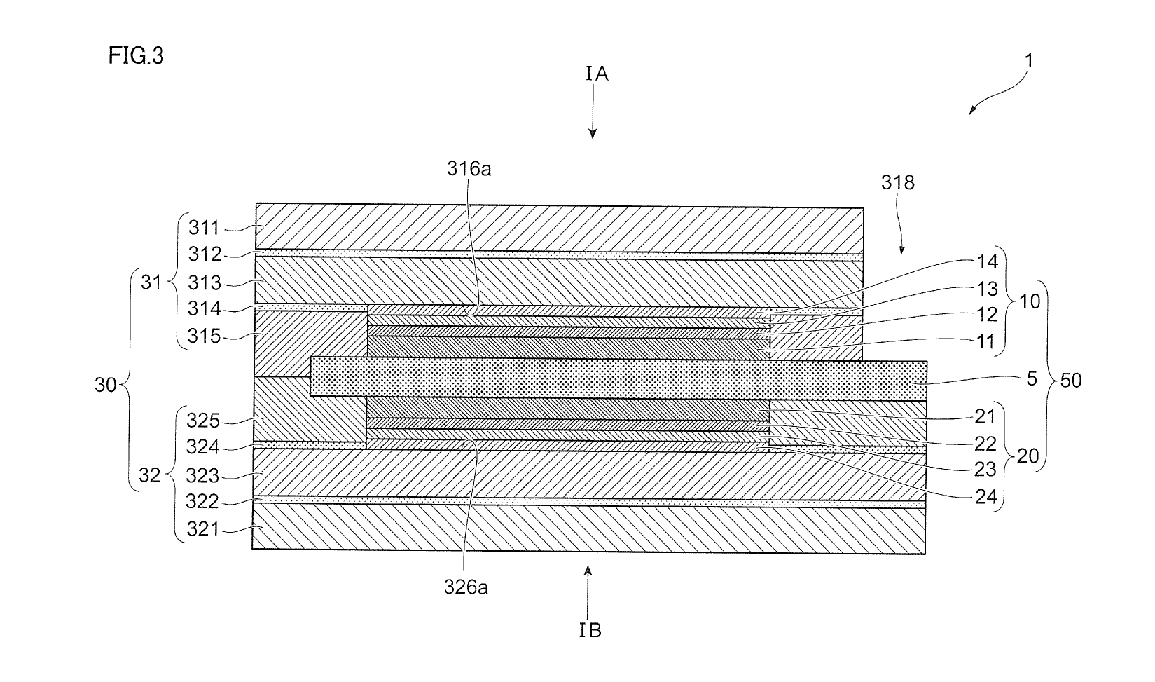

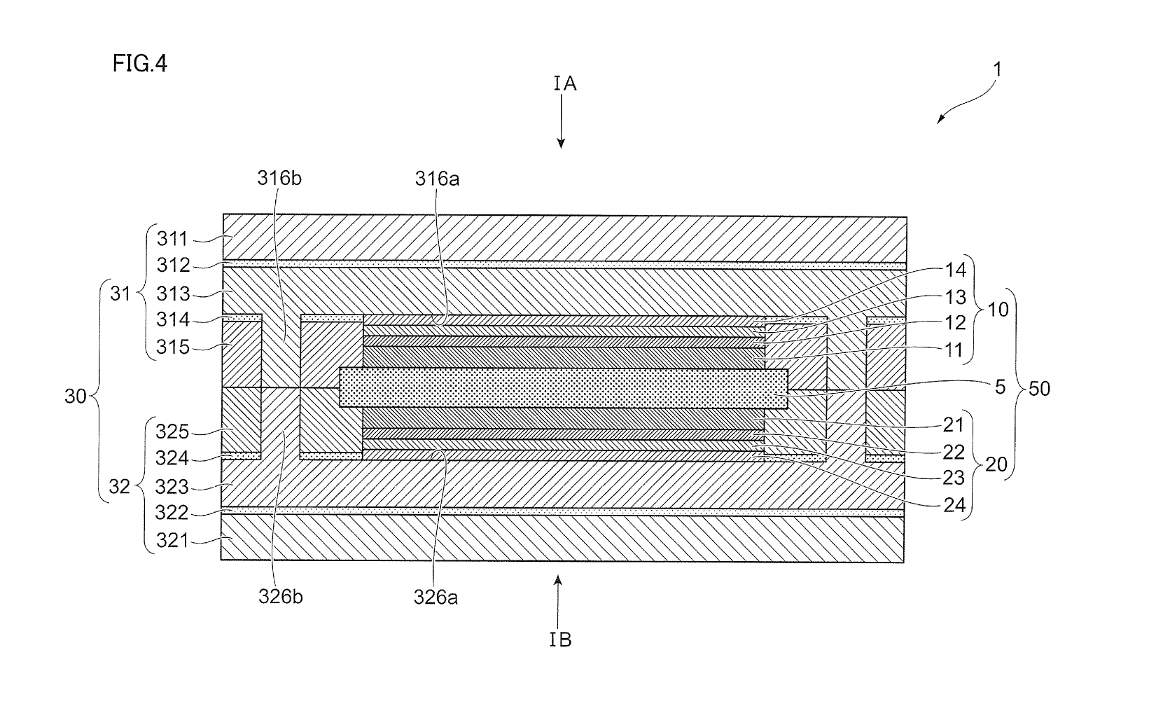

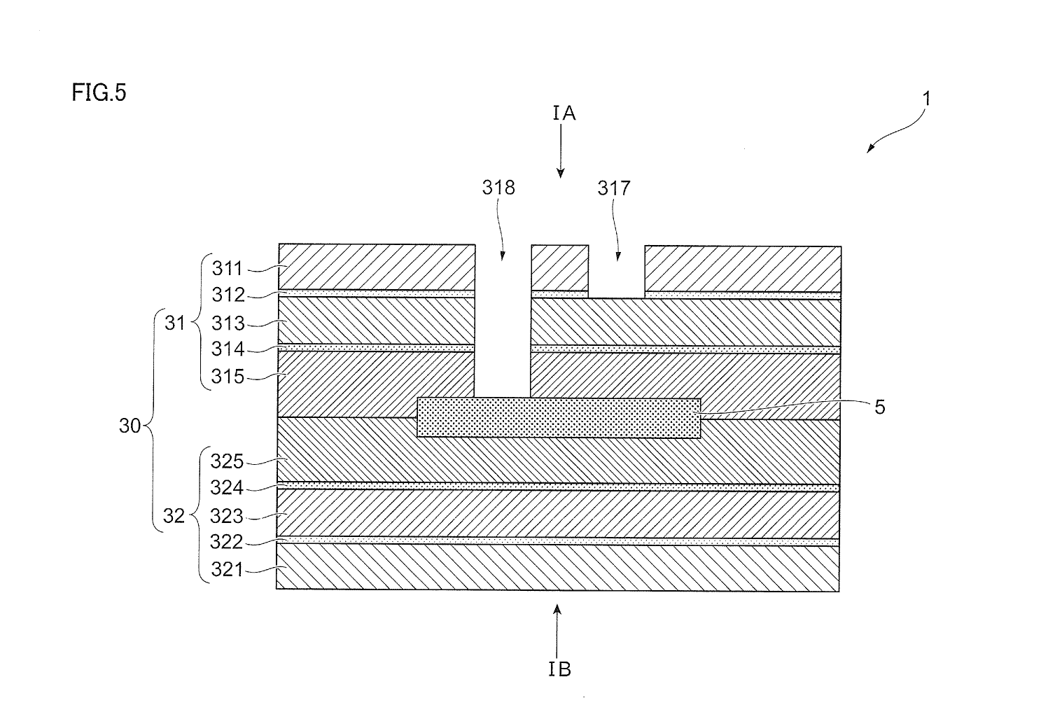

Moreover, FIG. 2, FIG. 3, FIG. 4 and FIG. 5 show a II-II cross-sectional view, a III-III cross-sectional view, a IV-IV cross-sectional view and a V-V cross-sectional view, respectively, of FIG. 1A. Note that FIG. 1A is a diagram viewing FIGS. 2 to 5 from the IA direction, and FIG. 1B is a diagram viewing FIGS. 2 to 5 from the IB direction.

The lithium-ion rechargeable battery 1 of the exemplary embodiment includes: a battery unit 50 including a first battery part 10 and a second battery part 20 that perform charge and discharge using lithium ion; and a shell 30 that seals the first battery part 10 and the second battery part 20 against outside air or the like by housing the first battery part 10 and the second battery part 20 in the interior thereof. The lithium-ion rechargeable battery 1 of the exemplary embodiment shows a rectangular-parallelepiped shape (in actuality, a card shape) as a whole.

### [Configuration of Battery Unit]

The battery unit 50 as an example of a battery structure of the lithium-ion rechargeable battery 1 includes: a substrate 5 that functions as one electrode (here, a positive electrode) in the lithium-ion rechargeable battery 1; the first battery part 10 provided to the one surface (referred to as a front surface) of the substrate 5; and the second battery part 20 provided to the other surface (referred to as a back surface) of the substrate 5. In the exemplary embodiment, as will be described later, since the first battery part 10 and the second battery part 20 are formed on the front and back surfaces of the substrate 5 by the sputtering method, the battery unit 50 has a configuration integrating the substrate 5, the first battery part 10 and the second battery part 20.

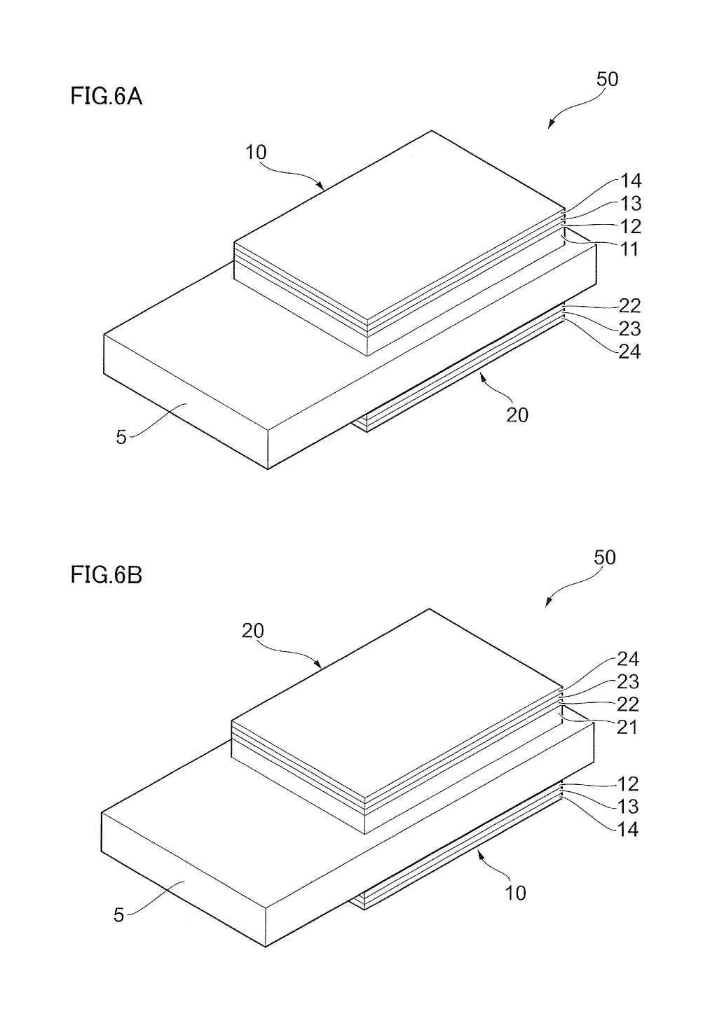

FIGS. 6A and 6B show diagrams for illustrating the configuration of the battery unit 50: FIG. 6A shows a perspective view that is viewed from the front side (in FIG. 2, from above); and FIG. 6B shows a perspective view that is viewed from the back side (in FIG. 2, from below). Hereinafter, the configuration of the battery unit 50 will be described with reference to FIG. 6 in addition to FIGS. 1A to 5.

### [Substrate]

The substrate 5 is not particularly limited as long as being a thin-plate shaped member having conductivity and being suitable to be deposited by the sputtering method, and, for example, various kinds of metal plates can be used. However, considering that the substrate 5 is used for forming the first battery part 10 and the second battery part 20 by the sputtering method, it is preferable to use stainless foil having high mechanical strength. Moreover, metallic foil, which is obtained by plating with conductive metals, such as nickel, tin, copper, chrome and the like, may be used. In the exemplary embodiment, as the substrate 5, the stainless foil was used.

The thickness of the substrate 5 can be set in the range of 20 μm or more and 200 μm or less. When the thickness of the substrate 5 is less than 20 μm, a pinhole or breaking is likely to occur in rolling or heat sealing in manufacturing the metallic foil, and in addition, the electrical resistance value when being used as the positive electrode is increased. On the other hand, when the thickness of the substrate 5 exceeds 200 μm, a volume energy density and a weight energy density are reduced by increases in the thickness and the weight of the battery. Moreover, flexibility of the battery is reduced. In the exemplary embodiment, the thickness of the substrate 5 was set to 30 μm.

### [First Battery Part]

The first battery part 10 as an example of a front surface battery portion includes: a first positive electrode layer 11 laminated on the front surface (the upper side in FIG. 2) of the substrate 5; a first solid electrolyte layer 12 laminated on the first positive electrode layer 11; a first negative electrode layer 13 laminated on the first solid electrolyte layer 12; and a first negative electrode collector layer 14 laminated on the first negative electrode layer 13. Here, the first positive electrode layer 11 positioned on one end portion of the first battery part 10 (the lower side in FIG. 2) is in contact with the front surface of the substrate 5. In contrast thereto, the first negative electrode collector layer 14 positioned on the other end portion of the first battery part 10 (the upper side in FIG. 2) is in contact with a first metal layer 313 provided to a first laminated film 31, which will be described later.

Each constituent of the first battery part 10 will be described in more detail.

### (First Positive Electrode Layer)

The first positive electrode layer 11 as an example of a front surface first polarity layer is not particularly limited as long as the layer is a solid thin film that contains a positive-electrode active material occluding and releasing lithium ions with a positive polarity as an example of a first polarity, and, for example, those configured with various kinds of materials, such as oxides, sulfides or phosphorus oxides containing at least one kind of metal selected from manganese (Mn), cobalt (Co), nickel (Ni), iron (Fe), molybdenum (Mo) and vanadium (V), may be used. In the exemplary embodiment, as the first positive electrode layer 11, Li₂Mn₂O₄ was used.

The thickness of the first positive electrode layer 11 can be set in the range of, for example, 10 nm or more and 40 μm or less. When the thickness of the first positive electrode layer 11 is less than 10 nm, the capacity of the first battery part 10 to be obtained becomes too small, and impractical. On the other hand, when the thickness of the first positive electrode layer 11 exceeds 40 μm, it takes too much time to form the layer, and thereby, the productivity is deteriorated. In the exemplary embodiment, the thickness of the first positive electrode layer 11 was set to 600 nm.

Moreover, it does not matter whether the first positive electrode layer 11 includes crystal structures or is in the amorphous state without including the crystal structures; however, in the point that expansion and contraction associated with occluding and releasing of lithium ions are more isotropic, it is preferable that the positive electrode layer 11 is in the amorphous state.

Further, as the manufacturing method of the first positive electrode layer 11, known deposition methods, such as various kinds of PVD (physical vapor deposition) or various kinds of CVD (chemical vapor deposition), may be used; however, in terms of production efficiency, it is desirable to use the sputtering method (sputtering). In this case, in accordance with a sputtering target to be used in forming the first positive electrode layer 11, the DC sputtering method or the RF sputtering method may be used. However, in the case where the above-described Li₂Mn₂O₄ is used for the first positive electrode layer 11, it is preferable to adopt the RF sputtering method.

### (First Solid Electrolyte Layer)

The first solid electrolyte layer 12 as an example of a front surface solid electrolyte layer is not particularly limited as long as being a solid thin film composed of an inorganic material (inorganic solid electrolyte) having lithium-ion conductivity, and those configured with various kinds of materials, such as oxides, nitrides or sulfides, may be used. In the exemplary embodiment, as the first solid electrolyte layer 12, LiPON (LiₓPO_{y}N_{z}), which was obtained by replacing a part of oxygen in Li₃PO₄ with nitrogen, was used.

The thickness of the first solid electrolyte layer 12 can be set in the range of, for example, 10 nm or more and 10 μm or less. When the thickness of the first solid electrolyte layer 12 is less than 10 nm, in the obtained first battery part 10, leakage is likely to occur between the first positive electrode layer 11 and the first negative electrode layer 13. On the other hand, when the thickness of the first solid electrolyte layer 12 exceeds 10 μm, the moving distance of lithium ion is elongated, and thereby, the charge and discharge rate is reduced. In the exemplary embodiment, the thickness of the first solid electrolyte layer 12 was set to 200 nm.

Moreover, it does not matter whether the first solid electrolyte layer 12 includes crystal structures or is in the amorphous state without including the crystal structures; however, in the point that expansion and contraction due to heat are more isotropic, it is preferable that the solid electrolyte layer 12 is in the amorphous state.

Further, as the manufacturing method of the first solid electrolyte layer 12, known deposition methods, such as various kinds of PVD (physical vapor deposition) or various kinds of CVD (chemical vapor deposition), may be used; however, in terms of production efficiency, it is desirable to use the sputtering method (sputtering). In this case, since many sputtering targets used in forming the first solid electrolyte layer 12 are insulating bodies, it is preferable to adopt the RF sputtering method.

### (First Negative Electrode Layer)

The first negative electrode layer 13 as an example of a front surface second polarity layer is not particularly limited as long as the layer is a solid thin film that contains a negative-electrode active material occluding and releasing lithium ions with a negative polarity as an example of a second polarity, and, for example, carbon (C) or silicon (Si) can be used. In the exemplary embodiment, as the first negative electrode layer 13, silicon (Si) added with boron (B) was used.

The thickness of the first negative electrode layer 13 can be set in the range of, for example, 10 nm or more and 40 μm or less. When the thickness of the first negative electrode layer 13 is less than 10 nm, the capacity of the first battery part 10 to be obtained becomes too small, and impractical. On the other hand, when the thickness of the first negative electrode layer 13 exceeds 40 μm, it takes too much time to form the layer, and thereby, the productivity is deteriorated. In the exemplary embodiment, the thickness of the first negative electrode layer 13 was set to 100 nm.

Moreover, it does not matter whether the first negative electrode layer 13 includes crystal structures or is in the amorphous state without including the crystal structures; however, in the point that expansion and contraction associated with occluding and releasing of lithium ions are more isotropic, it is preferable that the negative electrode layer 13 is in the amorphous state.

Further, as the manufacturing method of the first negative electrode layer 13, known deposition methods, such as various kinds of PVD (physical vapor deposition) or various kinds of CVD (chemical vapor deposition), may be used; however, in terms of production efficiency, it is desirable to use the sputtering method (sputtering). In this case, since many sputtering targets for forming the first negative electrode layer 13 are semiconductors, it is preferable to adopt the DC sputtering method.

### (First Negative Electrode Collector Layer)

The first negative electrode collector layer 14 is not particularly limited as long as being a solid thin film having electron conductivity, and it is possible to use, for example, metals such as titanium (Ti), aluminum (Al), copper (Cu), platinum (Pt) or gold (Au), or conductive materials containing alloys of these metals. In the exemplary embodiment, as the first negative electrode collector layer 14, titanium (Ti) was used.

The thickness of the first negative electrode collector layer 14 can be set in the range of, for example, 5 nm or more and 50 μm or less. When the thickness of the first negative electrode collector layer 14 is less than 5 nm, the power collection function is deteriorated, to thereby become impractical. On the other hand, when the thickness of the first negative electrode collector layer 14 exceeds 50 μm, it takes too much time to form the layer, and thereby, the productivity is deteriorated. In the exemplary embodiment, the thickness of the first negative electrode collector layer 14 was set to 200 nm.

Moreover, as the manufacturing method of the first negative electrode collector layer 14, known deposition methods, such as various kinds of PVD (physical vapor deposition) or various kinds of CVD (chemical vapor deposition), may be used; however, in terms of production efficiency, it is desirable to use the sputtering method (sputtering). In this case, since the sputtering target for forming the first negative electrode collector layer 14 is a metal (Ti), it is preferable to adopt the DC sputtering method.

### [Second Battery Part]

The second battery part 20 as an example of a back surface battery portion includes: the second positive electrode layer 21 laminated on the back surface (the lower side in FIG. 2) of the substrate 5; the second solid electrolyte layer 22 laminated on the second positive electrode layer 21; the second negative electrode layer 23 laminated on the second solid electrolyte layer 22; and the second negative electrode collector layer 24 laminated on the second negative electrode layer 23. Here, the second positive electrode layer 21 positioned on one end portion of the second battery part 20 (the upper side in FIG. 2) is in contact with the back surface of the substrate 5. In contrast thereto, the second negative electrode collector layer 24 positioned on the other end portion of the second battery part 20 (the lower side in FIG. 2) is in contact with a second metal layer 323 provided to a second laminated film 32, which will be described later.

Each constituent of the second battery part 20 will be described in more detail.

### (Second Positive Electrode Layer)

The second positive electrode layer 21 as an example of a back surface first polarity layer is not particularly limited as long as the layer is a solid thin film that contains a positive-electrode active material occluding and releasing lithium ions with a positive polarity as an example of the first polarity.

Then, as the second positive electrode layer 21, the material described in the above first positive electrode layer 11 can be used. At this time, the second positive electrode layer 21 and the first positive electrode layer 11 may be configured with the same material, or may be configured with different materials. Moreover, the thickness of the second positive electrode layer 21 may also be the same as or different from the thickness of the first positive electrode layer 11. However, in terms of equalizing the respective capacities of the first battery part 10 and the second battery part 20, it is preferable to equalize them. In the exemplary embodiment, as the second positive electrode layer 21, the 600 nm-thick Li₂Mn₂O₄ (amorphous) was used.

Moreover, the method for producing the second positive electrode layer 21 may be the same as or different from that of the first positive electrode layer 11; however, in terms of the production efficiency, it is preferable to adopt the same method, and further, it is more preferable to form the first positive electrode layer 11 and the second positive electrode layer 21 simultaneously.

### (Second Solid Electrolyte Layer)

The second solid electrolyte layer 22 as an example of a back surface solid electrolyte layer is not particularly limited as long as being a solid thin film composed of an inorganic material (inorganic solid electrolyte) and having lithium-ion conductivity.

Then, as the second solid electrolyte layer 22, the material described in the above first solid electrolyte layer 12 can be used. At this time, the second solid electrolyte layer 22 and the first solid electrolyte layer 12 may be configured with the same material, or may be configured with different materials. Moreover, the thickness of the second solid electrolyte layer 22 may also be the same as or different from the thickness of the first solid electrolyte layer 12. However, in terms of equalizing the respective capacities of the first battery part 10 and the second battery part 20, it is preferable to equalize them. In the exemplary embodiment, as the second solid electrolyte layer 22, the 200 nm-thick LiPON (LiₓPO_{y}N_{z}) (amorphous) was used.

Moreover, the method for producing the second solid electrolyte layer 22 may be the same as or different from that of the first solid electrolyte layer 12; however, in terms of the production efficiency, it is preferable to adopt the same method, and further, it is more preferable to form the first solid electrolyte layer 12 and the second solid electrolyte layer 22 simultaneously.

### (Second Negative Electrode Layer)

The second negative electrode layer 23 as an example of a back surface second polarity layer is not particularly limited as long as the layer is a solid thin film that contains a negative-electrode active material occluding and releasing lithium ions with a negative polarity as an example of the second polarity.

Then, as the second negative electrode layer 23, the material described in the above first negative electrode layer 13 can be used. At this time, the second negative electrode layer 23 and the first negative electrode layer 13 may be configured with the same material, or may be configured with different materials. Moreover, the thickness of the second negative electrode layer 23 may also be the same as or different from the thickness of the first negative electrode layer 13. However, in terms of equalizing the respective capacities of the first battery part 10 and the second battery part 20, it is preferable to equalize them. In the exemplary embodiment, as the second negative electrode layer 23, the 100 nm-thick silicon (Si) added with boron (B) (amorphous) was used.

Moreover, the method for producing the second negative electrode layer 23 may be the same as or different from that of the first negative electrode layer 13; however, in terms of the production efficiency, it is preferable to adopt the same method, and further, it is more preferable to form the first negative electrode layer 13 and the second negative electrode layer 23 simultaneously.

### (Second Negative Electrode Collector Layer)

The second negative electrode collector layer 24 is not particularly limited as long as being a solid thin film having lithium-ion conductivity.

Then, as the second negative electrode collector layer 24, the material described in the above first negative electrode collector layer 14 can be used. At this time, the second negative electrode collector layer 24 and the first negative electrode collector layer 14 may be configured with the same material, or may be configured with different materials. Moreover, the thickness of the second negative electrode collector layer 24 may also be the same as or different from the thickness of the first negative electrode collector layer 14. However, in terms of equalizing the respective capacities of the first battery part 10 and the second battery part 20, it is preferable to equalize them. In the exemplary embodiment, as the second negative electrode collector layer 24, the 100 nm-thick titanium (Ti) was used.

Moreover, the method for producing the second negative electrode collector layer 24 may be the same as or different from that of the first negative electrode collector layer 14; however, in terms of the production efficiency, it is preferable to adopt the same method, and further, it is more preferable to form the first negative electrode collector layer 14 and the second negative electrode collector layer 24 simultaneously.

### [Configuration of Shell]

Subsequently, a configuration of the shell 30 will be described.

The shell 30 as an example of a housing portion includes: the first laminated film 31 disposed on a side facing the first battery part 10 in the battery unit 50 (in FIG. 2, the upper side); and the second laminated film 32 disposed on a side facing the second battery part 20 in the battery unit 50 (in FIG. 2, the lower side). Then, by thermally adhering the first laminated film 31 and the second laminated film 32 around the entire circumference of the first battery part 10 and the second battery part 20, the first battery part 10 and the second battery part 20 are sealed.

### [First Laminated Film]

To begin with, the first laminated film 31 will be described.

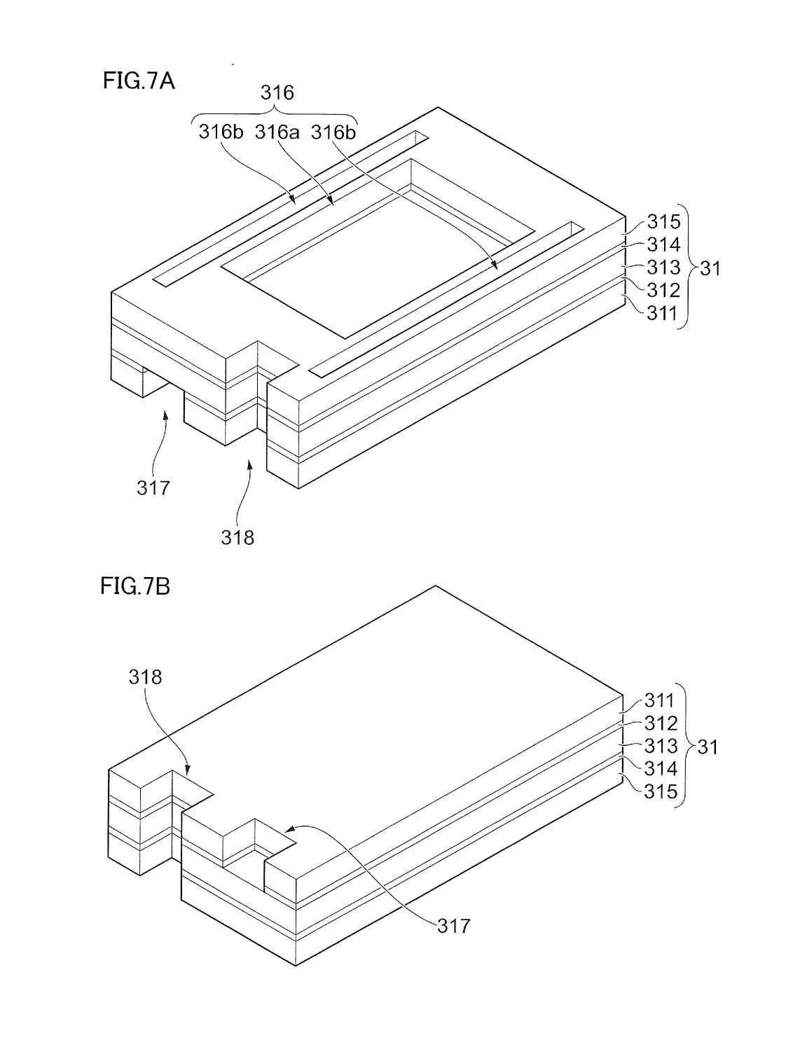

FIGS. 7A and 7B show diagrams for illustrating the configuration of the first laminated film 31: FIG. 7A shows a perspective view that is viewed from the back side (in FIG. 2, from below); and FIG. 7B shows a perspective view that is viewed from the front side (in FIG. 2, from above). Hereinafter, the configuration of the first laminated film 31 will be described with reference to FIGS. 7A and 7B in addition to FIGS. 1A to 6B.

The first laminated film 31 is configured by laminating a first heat-resistant resin layer 311, a first outside adhesion layer 312, the first metal layer 313, a first inside adhesion layer 314 and a first thermo-adhesive resin layer 315 in a film-like shape in this order. In other words, the first laminated film 31 is configured by bonding the first heat-resistant resin layer 311, the first metal layer 313 and the first thermo-adhesive resin layer 315 via the first outside adhesion layer 312 and the first inside adhesion layer 314.

Moreover, on a formation surface side of the first laminated film 31, on which the first thermo-adhesive resin layer 315 is formed (interior in the shell 30), there is provided a first inside exposed part 316 where a part of one surface of the first metal layer 313 (inside surface) is exposed due to absence of the first thermo-adhesive resin layer 315 and the first inside adhesion layer 314. The first inside exposed part 316 as an example of a first exposed portion includes a first battery exposure part 316a that shows a rectangular shape and is provided substantially at the center portion of the first laminated film 31, to thereby serve as a portion for housing the first battery part 10. Moreover, the first inside exposed part 316 includes first electrode exposure parts 316b each showing a rectangular shape and being provided in parallel across the first battery exposure part 316a, to thereby serve as portions for functioning as connection members.

Further, on a formation surface side of the first laminated film 31, on which the first heat-resistant resin layer 311 is formed (outside in the shell 30), there is provided a first outside exposed part 317 where a part of the other surface of the first metal layer 313 (an outside surface) is exposed due to absence of the first outside adhesion layer 312 and the first heat-resistant resin layer 311.

Still further, at a location, of the first laminated film 31, which is adjacent to the above-described first outside exposure part 317, there is provided a first cutout part 318 by integrally cutting the first heat-resistant resin layer 311, the first outside adhesion layer 312, the first metal layer 313, the first inside adhesion layer 314 and the first thermo-adhesive resin layer 315.

Next, each constituent of the first laminated film 31 will be described in more detail.

### (First Heat-Resistant Resin Layer)

The first heat-resistant resin layer 311 is the outermost layer in the shell 30, and a heat-resistant resin, which has high resistance to sticking from the outside, abrasion or the like, and is not melted at the adhesive temperature in thermally adhering the first thermo-adhesive resin layer 315, is used. Here, as the first heat-resistant resin layer 311, it is preferable to use a heat-resistant resin having a melting point not less than 10° C. higher than a melting point of a thermo-adhesive resin constituting the first thermo-adhesive resin layer 315, and particularly preferable to use a heat-resistant resin having a melting point not less than 20° C. higher than the melting point of the thermo-adhesive resin. Moreover, in the exemplary embodiment, as will be described later, the first metal layer 313 also serves as the negative electrode of the first battery part 10; therefore, in terms of safety, an insulating resin having high electrical resistance value is used as the first heat-resistant resin layer 311.

As the first heat-resistant resin layer 311, though not being particularly limited, examples thereof include polyamide films or polyester films, and oriented films thereof are preferably used. Among them, in terms of moldability and strength, it is particularly preferable to use a biaxially oriented polyamide film, a biaxially oriented polyester film or a multi-layered film containing these biaxially stretched films, and further, it is preferable to use a multi-layered film made by bonding the biaxially oriented polyamide film and the biaxially oriented polyester film. As the polyamide film, though not being particularly limited, examples thereof include a 6-polyamide film, a 6,6-polyamide film and an MXD polyamide film. Moreover, as the biaxially oriented polyester film, examples include a biaxially oriented polybutylene terephthalate (PBT) film and a biaxially oriented polyethylene terephthalate (PET) film. In the exemplary embodiment, as the first heat-resistant resin layer 311, a nylon film (the melting point: 220° C.) was used.

The thickness of the first heat-resistant resin layer 311 can be set in the range of 9 μm or more to 50 μm or less. When the thickness of the first heat-resistant resin layer 311 is less than 9 μm, it becomes difficult to secure the sufficient strength as the shell 30 of the first battery part 10 and the second battery part 20. On the other hand, when the thickness of the heat-resistant resin layer 311 exceeds 50 μm, since the battery becomes thick, it is not preferable, and the production costs are increased. In the exemplary embodiment, the thickness of the first heat-resistant resin layer 311 was set to 25 μm.

### (First Outside Adhesion Layer)

The first outside adhesion layer 312 adheres the first heat-resistant resin layer 311 and the first metal layer 313. As the first outside adhesion layer 312, for example, it is preferable to use two-pack curable type polyester-urethane resin by polyester resin as a base resin and polyfunctional isocyanate compound as a curing agent, or an adhesive agent containing polyether-urethane resin. In the exemplary embodiment, as the first outside adhesion layer 312, the two-pack curable type polyester-urethane adhesive agent was used.

### (First Metal Layer)

The first metal layer 313 has a role, when the shell 30 is configured by using the first laminated film 31, in preventing oxygen, moisture or the like from entering the battery part 10 and the second battery part 20, which is disposed inside of the shell 30, from the outside thereof (barriering the first battery part 10 and the second battery part 20, in particular, the first battery part 10). Moreover, as will be described later, the first metal layer 313 further has a role as a negative internal electrode, and a role as a negative external electrode of the first battery part 10, the negative external electrode being electrically connected to a load provided outside (not shown). Therefore, as the first metal layer 313, metallic foil having conductivity is used.

As the first metal layer 313, though not being particularly limited, for example, aluminum foil, copper foil, nickel foil, stainless foil, clad foil thereof, annealed foil or unannealed foil thereof and the like are preferably used. Moreover, metallic foil, which is obtained by plating with conductive metals, such as nickel, tin, copper, chrome and the like, may be used. In the exemplary embodiment, as the first metal layer 313, aluminum foil made of the A8021H-O material prescribed by JIS H4160 was used.

The thickness of the first metal layer 313 can be set in the range of 20 μm or more and 200 μm or less. When the thickness of the first metal layer 313 is less than 20 μm, a pinhole or breaking is likely to occur in rolling or heat sealing in manufacturing the metallic foil, and in addition, the electrical resistance value when being used as the electrode is increased. On the other hand, when the thickness of the first metal layer 313 exceeds 200 μm, there is a possibility that heat is dispersed in thermal adhesion and results in insufficient thermal adhesion. Moreover, since the battery gets thicker, it is not preferable. In the exemplary embodiment, the thickness of the first metal layer 313 was set to 40 μm.

### (First Inside Adhesion Layer)

The first inside adhesion layer 314 adheres the first metal layer 313 and the first thermo-adhesive resin layer 315. As the first inside adhesion layer 314, it is preferable to use an adhesive agent made of, for example, a polyurethane adhesive agent, an acrylic adhesive agent, an epoxy adhesive agent, a polyolefine adhesive agent, an elastomer adhesive agent, a fluorine adhesive agent or the like. Among them, it is preferable to use the acrylic adhesive agent or the polyolefine adhesive agent; in this case, the barrier properties of the first laminated film 31 against water vapor can be improved. Moreover, it is preferable to use an adhesive agent of acid-denaturated polypropylene, polyethylene or the like. In the exemplary embodiment, as the first inside adhesion layer 314, the acid-denaturated polypropylene adhesive agent was used.

### (First Thermo-Adhesive Resin Layer)

The first thermo-adhesive resin layer 315 as an example of a first resin layer is an innermost layer in the shell 30, and, as the thermo-adhesive resin layer 315, a thermoplastic resin, which has high resistance to the materials constituting respective layers of the first battery part 10 and the second battery part 20 and is melted at the above-described adhesive temperature, to thereby adhere to a second thermo-adhesive resin layer 325 (details thereof will be described later) of the second laminated film 32, is used. Moreover, in the exemplary embodiment, as described above, the first metal layer 313 also serves as the negative electrode of the first battery part 10; therefore, in terms of safety, an insulating resin having high electrical resistance value is used as the first thermo-adhesive resin layer 315.

As the first thermo-adhesive resin layer 315, though not being particularly limited, for example, polyethylene, polypropylene, olefin copolymer, acid denaturation and ionomer thereof and so forth are preferably used. Here, examples of the olefin copolymer include: EVA (ethylene vinyl acetate copolymer); EAA (ethylene acrylic acid copolymer); and EMAA (ethylene methacrylic acid copolymer). Moreover, as long as relationship of melting point with the first heat-resistant resin layer 311 can be satisfied, a polyamide film (for example, nylon 12) or a polyimide film can also be used. In the exemplary embodiment, as the first thermo-adhesive resin layer 315, a cast polypropylene film (the melting point: 165° C.) was used.

The thickness of the first thermo-adhesive resin layer 315 can be set in the range of 20 μm or more and 80 μm or less. When the thickness of the first thermo-adhesive resin layer 315 is less than 20 μm, pinholes are likely to occur. On the other hand, when the thickness of the first thermo-adhesive resin layer 315 exceeds 80 μm, since the battery becomes thick, it is not preferable. Moreover, since heat insulation properties are increased, there is a possibility of resulting in insufficient thermal adhesion. In the exemplary embodiment, the thickness of the first thermo-adhesive resin layer 315 was set to 30 μm.

### [Second Laminated Film]

Subsequently, the second laminated film 32 will be described.

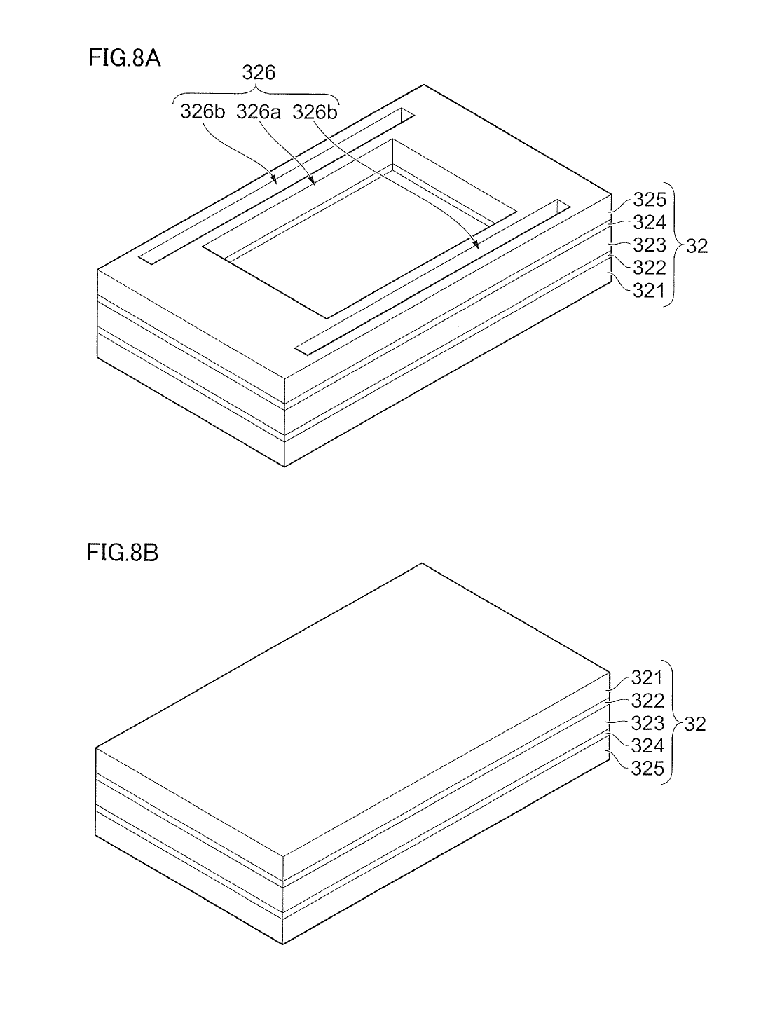

FIGS. 8A and 8B show diagrams for illustrating the configuration of the second laminated film 32: FIG. 8A shows a perspective view that is viewed from the front side (in FIG. 2, from above); and FIG. 8B shows a perspective view that is viewed from the back side (in FIG. 2, from below). Hereinafter, the configuration of the second laminated film 32 will be described with reference to FIGS. 8A and 8B in addition to FIGS. 1A to 7B.

The second laminated film 32 is configured by laminating a second heat-resistant resin layer 321, a second outside adhesion layer 322, the second metal layer 323, a second inside adhesion layer 324 and a second thermo-adhesive resin layer 325 in a film-like shape in this order. In other words, the second laminated film 32 is configured by bonding the second heat-resistant resin layer 321, the second metal layer 323 and the second thermo-adhesive resin layer 325 via the second outside adhesion layer 322 and the second inside adhesion layer 324.

Moreover, on a formation surface side of the second laminated film 32, on which the second thermo-adhesive resin layer 325 is formed (interior in the shell 30), there is provided a second inside exposed part 326 where a part of one surface of the second metal layer 323 (inside surface) is exposed due to absence of the second thermo-adhesive resin layer 325 and the second inside adhesion layer 324. The second inside exposed part 326 as an example of a second exposed portion includes a second battery exposure part 326a that shows a rectangular shape and is provided substantially at the center portion of the second laminated film 32, to thereby serve as a portion for housing the second battery part 20. Moreover, the second inside exposed part 326 includes second electrode exposure parts 326b each showing a rectangular shape and being provided in parallel across the second battery exposure part 326a, to thereby serve as portions for functioning as connection members.

Note that, in the second laminated film 32, different from the above-described first laminated film 31, an outside exposed part, where a part of the other surface of the second metal layer 323 (an outside surface) is exposed due to absence of the second outside adhesion layer 322 and the second heat-resistant resin layer 321, is not provided. Moreover, in the second laminated film 32, different from the above-described first laminated film 31, a cutout part formed by integrally cutting the second heat-resistant resin layer 321, the second outside adhesion layer 322, the second metal layer 323, the second inside adhesion layer 324 and the second thermo-adhesive resin layer 325 is not provided either.

Next, each constituent of the second laminated film 32 will be described in more detail.

### (Second Heat-Resistant Resin Layer)

The second heat-resistant resin layer 321 is the outermost layer in the shell 30, and a heat-resistant resin, which has high resistance to sticking from the outside, abrasion or the like, and is not melted at the adhesive temperature in thermally adhering the second thermo-adhesive resin layer 325, is used. Moreover, in the exemplary embodiment, as will be described later, the second metal layer 323 also serves as the negative electrode of the second battery part 20; therefore, in terms of safety, an insulating resin having high electrical resistance value is used as the second heat-resistant resin layer 321.

Then, as the second heat-resistant resin layer 321, the material described in the above first heat-resistant resin layer 311 can be used. At this time, the second heat-resistant resin layer 321 and the first heat-resistant resin layer 311 may be configured with the same material, or may be configured with different materials. Moreover, the thickness of the second heat-resistant resin layer 321 may also be the same as or different from the thickness of the first heat-resistant resin layer 311. In the exemplary embodiment, as the second heat-resistant resin layer 321, a 25 μm-thick nylon film (the melting point: 220° C.) was used.

### (Second Outside Adhesion Layer)

The second outside adhesion layer 322 adheres the second heat-resistant resin layer 321 and the second metal layer 323.

Then, as the second outside adhesion layer 322, the material described in the above first outside adhesion layer 312 can be used. At this time, the second outside adhesion layer 322 and the first outside adhesion layer 312 may be configured with the same material, or may be configured with different materials. In the exemplary embodiment, as the second outside adhesion layer 322, the two-pack curable type polyester-urethane adhesive agent was used.

### (Second Metal Layer)

The second metal layer 323 has a role, when the shell 30 is formed by using the second laminated film 32, in preventing oxygen, moisture or the like from entering the first battery part 10 and the second battery part 20, which is disposed inside of the shell 30, from the outside thereof (barriering the first battery part 10 and the second battery part 20, in particular, the second battery part 20). Moreover, as will be described later, the second metal layer 323 further has a role as a negative internal electrode of the second battery part 20. Therefore, as the second metal layer 323, metallic foil having conductivity is used.

Then, as the second metal layer 323, the material described in the above first metal layer 313 can be used. At this time, the second metal layer 323 and the first metal layer 313 may be configured with the same material, or may be configured with different materials. Moreover, the thickness of the second metal layer 323 may also be the same as or different from the thickness of the first metal layer 313. In the exemplary embodiment, as the second metal layer 323, 40 μm-thick aluminum foil made of the A8021H-O material prescribed by JIS H4160 was used.

### (Second Inside Adhesion Layer)

The second inside adhesion layer 324 adheres the second metal layer 323 and the second thermo-adhesive resin layer 325.

Then, as the second inside adhesion layer 324, the material described in the above first inside adhesion layer 314 can be used. At this time, the second inside adhesion layer 324 and the first inside adhesion layer 314 may be configured with the same material, or may be configured with different materials. In the exemplary embodiment, as the second inside adhesion layer 324, the acid-denaturated polypropylene adhesive agent was used.

### (Second Thermo-Adhesive Resin Layer)

The second thermo-adhesive resin layer 325 as an example of a second resin layer is an innermost layer in the shell 30, and, as the thermo-adhesive resin layer 325, a thermoplastic resin, which has high resistance to the materials constituting respective layers of the first battery part 10 and the second battery part 20 and is melted at the above-described adhesive temperature, to thereby adhere to the first thermo-adhesive resin layer 315 of the first laminated film 31, is used. Moreover, in the exemplary embodiment, as described above, the second metal layer 323 also serves as the negative electrode of the second battery part 20; therefore, in terms of safety, an insulating resin having high electrical resistance value is used as the second thermo-adhesive resin layer 325.

Then, as the second thermo-adhesive resin layer 325, the material described in the above first thermo-adhesive resin layer 315 can be used. At this time, the second thermo-adhesive resin layer 325 and the first thermo-adhesive resin layer 315 may be configured with the same material, or may be configured with different materials. Moreover, the thickness of the second thermo-adhesive resin layer 325 may also be the same as or different from the thickness of the first thermo-adhesive resin layer 315. In the exemplary embodiment, as the second thermo-adhesive resin layer 325, a 30 μm-thick cast polypropylene film (the melting point: 165° C.) was used.

### [Electrical Connection Structure in Lithium-Ion Rechargeable Battery]

Here, electrical connection structure in the lithium-ion rechargeable battery 1 of the exemplary embodiment will be described.

To begin with, in the first battery part 10, the first positive electrode layer 11, the first solid electrolyte layer 12, the first negative electrode layer 13 and the first negative electrode collector layer 14 are electrically connected in this order. Moreover, in the second battery part 20, the second positive electrode layer 21, the second solid electrolyte layer 22, the second negative electrode layer 23 and the second negative electrode collector layer 24 are electrically connected in this order. Then, in the battery unit 50, on the front surface and the back surface of the substrate 5, first positive electrode layer 11 of the first battery part 10 and the second positive electrode layer 21 of the second battery part 20 are electrically connected, respectively.

The first negative electrode collector layer 14 of the first battery part 10 is electrically connected to a portion, of one surface (inside surface) of the first metal layer 313 provided to the first laminated film 31, exposed to the first battery exposure part 316a. Moreover, the second negative electrode collector layer 24 of the second battery part 20 is electrically connected to a portion, of one surface (inside surface) of the second metal layer 323 provided to the second laminated film 32, exposed to the second battery exposure part 326a. Further, the first metal layer 313 provided to the first laminated film 31 and the second metal layer 323 provided to the second laminated film 32 are electrically connected at the area where the first electrode exposure parts 316b and the second electrode exposure parts 326b face each other.

Here, for example, in FIG. 4, it is depicted that the first metal layer 313 is projected at a formation area of the first electrode exposure part 316b in the first laminated film 31 and the second metal layer 323 is projected at a formation area of the second electrode exposure part 326b in the second laminated film 32, and thereby the first metal layer 313 and the second metal layer 323 are in contact; however, actually this is not true. In other words, actually, both of the first thermo-adhesive resin layer 315 provided to the first laminated film 31 and the second thermo-adhesive resin layer 325 provided to the second laminated film 32 are crushed in adhesion, and therefore, the first metal layer 313 and the second metal layer 323 are brought into contact at the formation areas of the first electrode exposure part 316b and the second electrode exposure part 326b.

Moreover, the substrate 5 is exposed to the outside at the formation area of the first cutout part 318 in the first laminated film 31; accordingly, the portion is able to be electrically connected, as a positive electrode, to the load (not shown) provided outside. In contrast thereto, a part of the other surface (outside surface) of the first metal layer 313 provided to the first laminated film 31 is exposed to the outside at the first outside exposed part 317; accordingly, the portion can be electrically connected, as a negative electrode, to the load (not shown) provided outside.

Consequently, in this example, the substrate 5 serves as the positive electrode of the lithium-ion rechargeable battery 1, and the first metal layer 313 provided to the first laminated film 31 serves as the negative electrode of the lithium-ion rechargeable battery 1. Moreover, in this example, while the positive electrode side of the first battery part 10 and the positive electrode side of the second battery part 20 are connected to the substrate 5, the negative electrode side of the first battery part 10 and the negative electrode side of the second battery part 20 are electrically connected to the first metal layer 313 and the second metal layer 323, respectively, and further, the first metal layer 313 and the second metal layer 323 are electrically connected. Accordingly, in the lithium-ion rechargeable battery 1, the first battery part 10 and the second battery part 20 are connected in parallel. Here, the substrate 5 serving as the positive electrode side and the first metal layer 313 and the second metal layer 323 serving as the negative electrode side are electrically insulated by the first thermo-adhesive resin layer 315 provided to the first laminated film 31 and the second thermo-adhesive resin layer 325 provided to the second laminated film 32.

### [Method for Producing Lithium-Ion Rechargeable Battery]

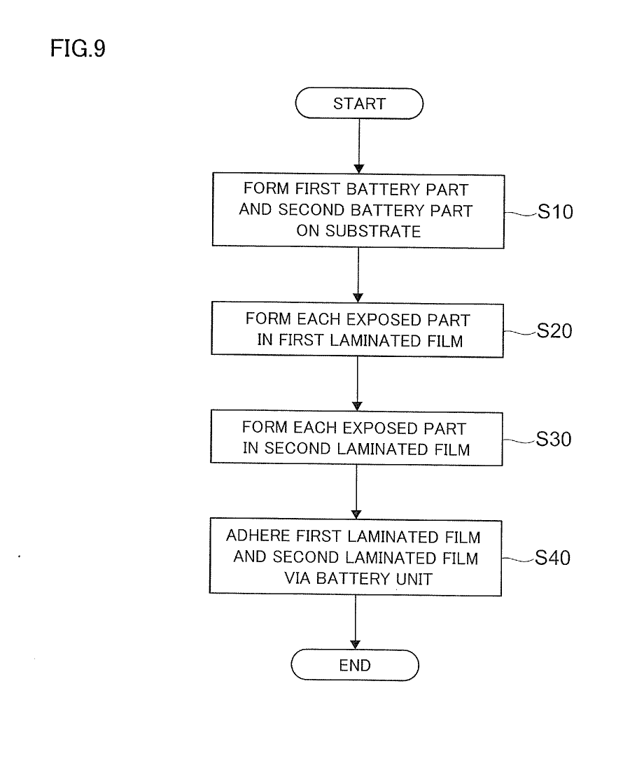

FIG. 9 is a flowchart for illustrating a method of producing the lithium-ion rechargeable battery 1 shown in FIG. 1 and so forth.

### (Battery Unit Formation Process)

To begin with, the first battery part 10 is formed on the front surface of the substrate 5, and the second battery part 20 is formed on the back surface thereof (step 10). In other words, on the front surface of the substrate 5, the first positive electrode layer 11, the first solid electrolyte layer 12, the first negative electrode layer 13 and the first negative electrode collector layer 14 are formed in this order, and, on the back surface of the substrate 5, the second positive electrode layer 21, the second solid electrolyte layer 22, the second negative electrode layer 23 and the second negative electrode collector layer 24 are formed in this order, to thereby obtain the battery unit 50 including the substrate 5, the first battery part 10 and the second battery part 20. Note that the details of step 10 will be described later.

### (First Laminated Film Exposed Portion Formation Process)

Next, from the first laminated film 31 formed by bonding the first heat-resistant resin layer 311, the first metal layer 313 and the first thermo-adhesive resin layer 315 via the first outside adhesion layer 312 and the first inside adhesion layer 314, a part of the first heat-resistant resin layer 311 to the first thermo-adhesive resin layer 315 is removed. Consequently, in the first laminated film 31, the first inside exposed part 316 (the first battery exposure part 316a and the first electrode exposure parts 316b), the first outside exposed part 317 and the first cutout part 318 are formed (step 20).

### (Second Laminated Film Exposed Portion Formation Process)

Moreover, from the second laminated film 32 formed by bonding the second heat-resistant resin layer 321, the second metal layer 323 and the second thermo-adhesive resin layer 325 via the second outside adhesion layer 322 and the second inside adhesion layer 324, a part of the second thermo-adhesive resin layer 325 and the second inside adhesion layer 324 is removed. Consequently, in the second laminated film 32, the second inside exposed part 326 (the second battery exposure part 326a and the second electrode exposed parts 326b) is formed (step 30).

### (Adhesion Process)

Subsequently, for example, into a working box filled with inert gas, such as N₂ gas or the like, the battery part 50, the first laminated film 31 and the second laminated film 32 are introduced. Then, the first negative electrode collector layer 14 provided to the first battery part 10 of the battery unit 50 and the first electrode exposure parts 316b provided to the first laminated film 31 are caused to face each other, and the second negative electrode collector layer 24 provided to the second battery part 20 of the battery unit 50 and the second battery exposure part 326a provided to the second laminated film 32 are caused to face each other. At this time, the first thermo-adhesive resin layer 315 of the first laminated film 31 and the second thermo-adhesive resin layer 325 of the second laminated film 32 face each other across the battery unit 50, and the two first electrode exposure parts 316b provided to the first laminated film 31 and the two second electrode exposure parts 326b provided to the second laminated film 32 are made to face each other. Moreover, at this time, one end portion side of the substrate 5 constituting the battery unit 50 is made to be exposed at the first cutout part 318 provided to the first laminated film 31.

Thereafter, in a state where the interior of the working box is set to the negative pressure, the first thermo-adhesive resin layer 315 in the first laminated film 31 and the second thermo-adhesive resin layer 325 in the second laminated film 32 are adhered at outer entire circumference of the periphery of the first battery part 10 the second battery part 20 while being pressurized and heated (step 40). Then, due to the first thermo-adhesive resin layer 315 and the second thermo-adhesive resin layer 325 being thermally adhered, the lithium-ion rechargeable battery 1 including the substrate 5, the first battery part 10, the second battery part 20 and the shell 30 that seals the first battery part 10 and the second battery part 20 is obtained.

At this time, the battery unit 50 is in a state in which the substrate 5, the first battery part 10 and the second battery part 20 are joined (integrated) by deposition by the sputtering method. Moreover, the first negative electrode collector layer 14 of the first battery part 10 and the first metal layer 313 of the first laminated film 31 are brought into a state of being tightly adhered by thermally adhering the first thermo-adhesive resin layers 315 of the first laminated film 31 and the second thermo-adhesive resin layer 325 of the second laminated film 32 under the negative pressure. Further, the second negative electrode collector layer 24 of the second battery part 20 and the second metal layer 323 of the second laminated film 32 are brought into a state of being tightly adhered by thermally adhering the first thermo-adhesive resin layers 315 of the first laminated film 31 and the second thermo-adhesive resin layer 325 of the second laminated film 32 under the negative pressure. Then, the first metal layer 313 of the first laminated film 31 and the second metal layer 323 of the second laminated film 32 are brought into a state of being tightly adhered by thermally adhering the first thermo-adhesive resin layers 315 of the first laminated film 31 and the second thermo-adhesive resin layer 325 of the second laminated film 32 under the negative pressure.

### [Method for Producing Battery Unit]

Now, producing procedures of the battery unit 50 in the above step 10 will be described by taking specific examples.

### (Formation of First Positive Electrode Layer and Second Positive Electrode Layer)

First, the substrate 5 was placed in a deposition chamber (chamber) in a not-shown sputtering device. At this time, the front and back surfaces of the substrate 5 were made to face each of two sputtering targets. After the substrate 5 was placed in the chamber, Ar gas containing 5% O₂ gas was introduced to set the pressure in the chamber at 0.8 Pa. Then, by use of two sputtering targets having a composition of Li₂Mn₂O₄, formation (deposition) of the first positive electrode layer 11 was performed on the front surface of the substrate 5 and formation (deposition) of the second positive electrode layer 21 was performed on the back surface of the substrate 5 by the RF sputtering method. In other words, formation (deposition) of first positive electrode layer 11 and the second positive electrode layer 21 was simultaneously performed. The film composition of each of the first positive electrode layer 11 and the second positive electrode layer 21 thus obtained was Li₂Mn₂O₄, the thickness of each thereof was 600 nm, and the crystal structure of each thereof was amorphous.

### (Formation of First Solid Electrolyte Layer and Second Solid Electrolyte Layer)

Next, N₂ gas was introduced to set the pressure in the chamber at 0.8 Pa. Then, by use of two sputtering targets having a composition of Li₃PO₄, formation (deposition) of the first solid electrolyte layer 12 was performed on the first positive electrode layer 11 and formation (deposition) of the second solid electrolyte layer 22 was performed on the second positive electrode layer 21 by the RF sputtering method. In other words, formation (deposition) of first solid electrolyte layer 12 and the second solid electrolyte layer 22 was simultaneously performed. The film composition of each of the first solid electrolyte layer 12 and the second solid electrolyte layer 22 thus obtained was LiPON, the thickness of each thereof was 200 nm, and the crystal structure of each thereof was amorphous.

### (Formation of First Negative Electrode Layer and Second Negative Electrode Layer)

Subsequently, Ar gas was introduced to set the pressure in the chamber at 0.8 Pa. Then, by use of two sputtering targets composed of silicon (Si) doped with boron (B) (P-type Si sputtering targets), formation (deposition) of the first negative electrode layer 13 was performed on the first solid electrolyte layer 12 and formation (deposition) of the second negative electrode layer 23 was performed on the second solid electrolyte layer 22 by the DC sputtering method. In other words, formation (deposition) of first negative electrode layer 13 and the second negative electrode layer 23 was simultaneously performed. The film composition of each of the first negative electrode layer 13 and the second negative electrode layer 23 thus obtained was Si doped with B, the thickness of each thereof was 100 nm, and the crystal structure of each thereof was amorphous.

### (Formation of First Negative Electrode Collector Layer and Second Negative Electrode Collector Layer)

Further, in a state where Ar gas was introduced to set the pressure in the chamber at 0.8 Pa, by use of two sputtering targets composed of titanium (Ti), formation (deposition) of the first negative electrode collector layer 14 was performed on the first negative electrode layer 13 and formation (deposition) of the second negative electrode collector layer 24 was performed on the second negative electrode layer 23 by the DC sputtering method. In other words, formation (deposition) of first negative electrode collector layer 14 and the second negative electrode collector layer 24 was simultaneously performed. The film composition of each of the first negative electrode collector layer 14 and the second negative electrode collector layer 24 thus obtained was Ti, and the thickness of each thereof was 200 nm.

With the above procedures, by forming the first battery part 10 and the second battery part 20 on the front and back surfaces of the substrate 5, the battery unit 50 was obtained. Then, the obtained battery unit 50 was taken out of the chamber.

### Conclusion of Exemplary Embodiment

As described above, according to the exemplary embodiment, the first battery part 10 and the second battery part 20 were formed on the front and back surfaces, respectively, of the common substrate 5, and the first battery part 10 and the second battery part 20 were housed inside of the shell 30. Moreover, in the exemplary embodiment, the metal layers provided to the shell 30 (the first metal layer 313 and the second metal layer 323) were connected to the first battery part 10 and the second battery part 20, and further, the first metal layer 313 and the second metal layer 323 were connected. Consequently, since the first battery part 10 and the second battery part 20 can be connected in parallel in the shell 30, it is possible to increase a capacity of the thin-film type lithium-ion rechargeable battery 1 including a solid electrolyte (the first solid electrolyte layer 12 and the second solid electrolyte layer 22) with a simple configuration.

### Modified Example

In the lithium-ion rechargeable battery 1 of the above-described exemplary embodiment, the first battery part 10 included the first negative electrode collector layer 14 and the second battery part 20 included the second negative electrode collector layer 24; however, the first negative electrode collector layer 14 and the second negative electrode collector layer 24 are not essential.

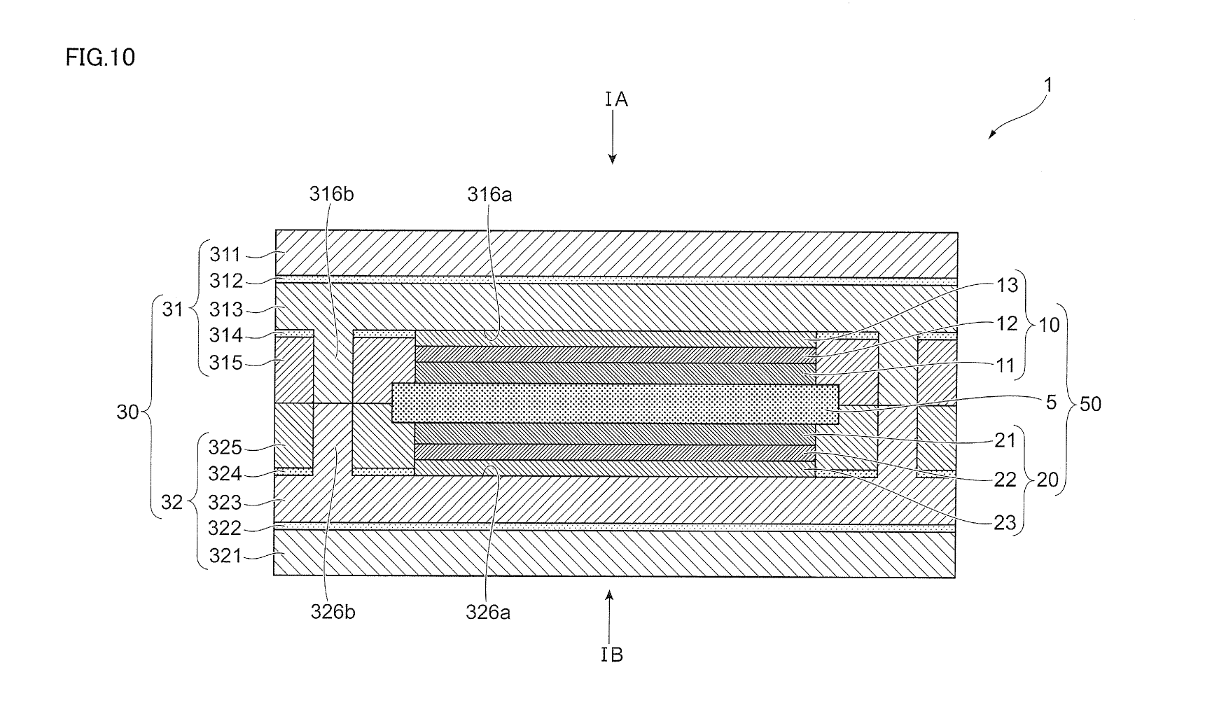

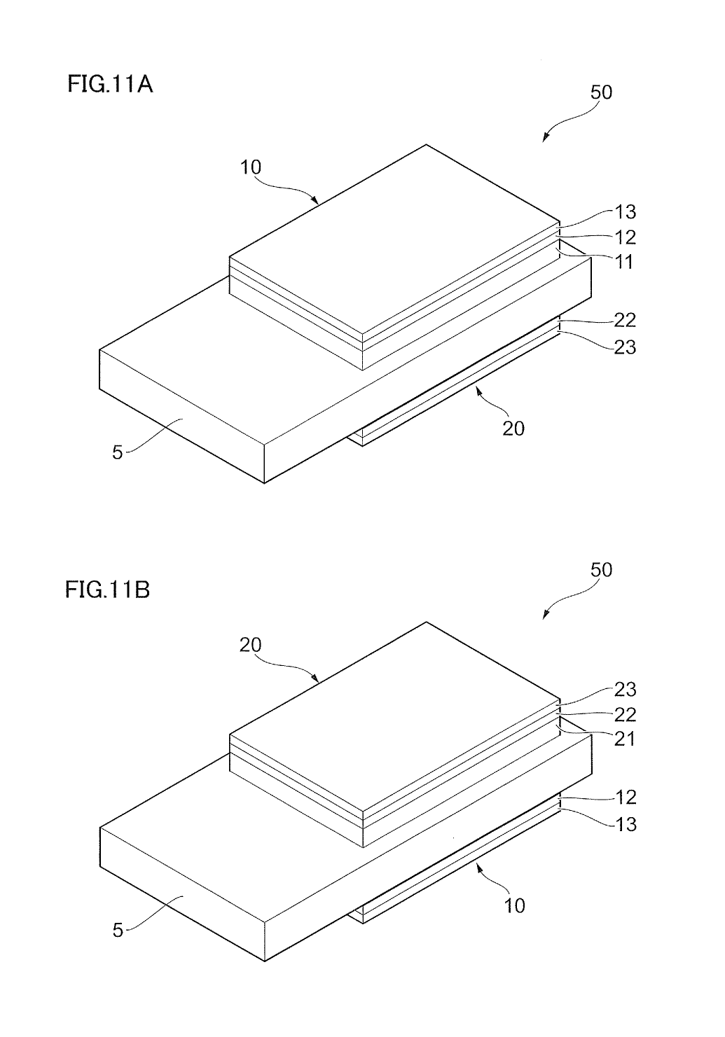

FIG. 10 is a diagram for illustrating a modified example of the exemplary embodiment, which is a IV-IV cross-sectional view of FIG. 1A. Moreover, FIGS. 11A and 11B are perspective views of the battery unit 50 in the modified example of the exemplary embodiment.

In the modified example of the exemplary embodiment, the first battery part 10 constituting the battery unit 50 includes: the first positive electrode layer 11 laminated on one surface of the substrate 5; the first solid electrolyte layer 12 laminated on the first positive electrode layer 11; and the first negative electrode layer 13 laminated on the first solid electrolyte layer 12. Then, the first negative electrode layer 13 positioned on the other end portion of the first battery part 10 (the upper side in FIG. 10) is in direct contact with the first metal layer 313 exposed to the first battery exposure part 316a of the first laminated film 31.

Moreover, the second battery part 20 constituting the battery unit 50 includes: the second positive electrode layer 21 laminated on the other surface of the substrate 5; the second solid electrolyte layer 22 laminated on the second positive electrode layer 21; and the second negative electrode layer 23 laminated on the second solid electrolyte layer 22. Then, the second negative electrode layer 23 positioned on the other end portion of the second battery part 20 (the lower side in FIG. 10) is in direct contact with the second metal layer 323 exposed to the second battery exposure part 326a of the second laminated film 32.

By adopting such a configuration, as compared to the configuration described in the exemplary embodiment, it is possible to simplify the structure of the lithium-ion rechargeable battery 1.

### [Others]

Note that, in the exemplary embodiment and the modified example, the positive electrode layers (the first positive electrode layer 11 and the second positive electrode layer 21) are disposed closer to the substrate 5, and the negative electrode layers (the first negative electrode layer 13 and the second negative electrode layer 23) are disposed closer to the metal layers (the first metal layer 313 and the second metal layer 323) constituting the shell 30; however, dispositions are not limited thereto, and dispositions may be opposite. In other words, it may be possible to dispose the negative electrode side of each battery part closer to the substrate 5 and to dispose the positive electrode side of each battery part closer to each laminated film (each metal layer).

Moreover, in the exemplary embodiment, the first metal layer 313 provided to the first laminated film 31 and the second metal layer 323 provided to the second laminated film 32 are electrically connected via the first electrode exposure parts 316b and the second electrode exposure parts 326b provided at two locations; however, at least one location is necessary.

Further, in the exemplary embodiment, the first negative electrode collector layer 14 of the first battery part 10 (in the modified example, the first negative electrode layer 13) and the first metal layer 313 of the first laminated film 31 were brought into contact (tightly adhered) in the state of not being fixed and the second negative electrode collector layer 24 of the second battery part 20 (in the modified example, the second negative electrode layer 23) and the second metal layer 323 of the second laminated film 32 were brought into contact (tightly adhered) in the state of not being fixed; however, the present invention is not limited thereto, and it may be possible to fix the positional relationship thereof by use of, for example, a conductive adhesive agent or the like.

### REFERENCE SIGNS LIST

1 Lithium-ion rechargeable battery
5 Substrate
10 First battery part
11 First positive electrode layer
12 First solid electrolyte layer
13 First negative electrode layer
14 First negative electrode collector layer
20 Second battery part
21 Second positive electrode layer
22 Second solid electrolyte layer
23 Second negative electrode layer
24 Second negative electrode collector layer
30 Shell
31 First laminated film
32 Second laminated film
50 Battery unit
311 First heat-resistant resin layer
312 First outside adhesion layer
313 First metal layer
314 First inside adhesion layer
315 First thermo-adhesive resin layer
316 First inside exposed part
316a First battery exposure part
316b First electrode exposure part
317 First outside exposed part
318 First cutout part
321 Second heat-resistant resin layer
322 Second outside adhesion layer
323 Second metal layer
324 Second inside adhesion layer
325 Second thermo-adhesive resin layer
326 Second inside exposed part
326a Second battery exposure part
326b Second electrode exposure part

1-8. (canceled)

9. A lithium-ion rechargeable battery comprising:
a substrate having conductivity;
a front surface battery part including a front surface first polarity layer laminated on a front surface side of the substrate to occlude and release a lithium ion with a first polarity, a front surface solid electrolyte layer laminated on the front surface first polarity layer and including an inorganic solid electrolyte having lithium-ion conductivity, and a front surface second polarity layer laminated on the front surface solid electrolyte layer to occlude and release a lithium ion with a second polarity, which is opposite to the first polarity;
a back surface battery part including a back surface first polarity layer laminated on a back surface side of the substrate to occlude and release a lithium ion with the first polarity, a back surface solid electrolyte layer laminated on the back surface first polarity layer and including an inorganic solid electrolyte having lithium-ion conductivity, and a back surface second polarity layer laminated on the back surface solid electrolyte layer to occlude and release a lithium ion with the second polarity; and
a housing portion including a metal layer and a resin layer laminated on the metal layer to form an exposed portion where a part of the metal layer is exposed, and housing the front surface battery portion and the back surface battery portion inside thereof, the metal layer being electrically connected to the front surface second polarity layer and the back surface second polarity layer at the exposed portion.

10. The lithium-ion rechargeable battery according to claim 9, wherein
the housing portion comprises:
a first laminated film including a first metal layer as the metal layer and a first resin layer as the resin layer laminated on the first metal layer to form a first exposed portion, where a part of the first metal layer is exposed, on one surface of the first metal layer, the front surface second polarity layer being electrically connected to the first metal layer exposed at the first exposed portion; and
a second laminated film including a second metal layer as the metal layer and a second resin layer as the resin layer laminated on the second metal layer to form a second exposed portion, where a part of the second metal layer is exposed, on one surface of the second metal layer, the back surface second polarity layer being electrically connected to the second metal layer exposed at the second exposed portion, wherein
the first metal layer exposed at the first exposed portion and the second metal layer exposed at the second exposed portion are electrically connected, and the front surface battery portion and the back surface battery portion are sealed between the first laminated film and the second laminated film.

11. The lithium-ion rechargeable battery according to claim 9, wherein the substrate is configured with stainless steel and the metal layer is configured with aluminum.

12. The lithium-ion rechargeable battery according to claim 10, wherein the substrate is configured with stainless steel and the metal layer is configured with aluminum.

13. The lithium-ion rechargeable battery according to claim 10, wherein
the front surface second polarity layer provided to the front surface battery part and the first metal layer exposed at the first exposed portion of the first laminated film are in direct contact, and
the back surface second polarity layer provided to the back surface battery part and the second metal layer exposed at the second exposed portion of the second laminated film are in direct contact.

14. The lithium-ion rechargeable battery according to claim 11, wherein
the front surface second polarity layer provided to the front surface battery part and the first metal layer exposed at the first exposed portion of the first laminated film are in direct contact, and
the back surface second polarity layer provided to the back surface battery part and the second metal layer exposed at the second exposed portion of the second laminated film are in direct contact.

15. The lithium-ion rechargeable battery according to claim 12, wherein
the front surface second polarity layer provided to the front surface battery part and the first metal layer exposed at the first exposed portion of the first laminated film are in direct contact, and
the back surface second polarity layer provided to the back surface battery part and the second metal layer exposed at the second exposed portion of the second laminated film are in direct contact.

16. A battery structure of a lithium-ion rechargeable battery comprising:
a substrate having conductivity;
a front surface battery part including a front surface first polarity layer laminated on a front surface side of the substrate to occlude and release a lithium ion with a first polarity, a front surface solid electrolyte layer laminated on the front surface first polarity layer and including an inorganic solid electrolyte having lithium-ion conductivity, and a front surface second polarity layer laminated on the front surface solid electrolyte layer to occlude and release a lithium ion with a second polarity, which is opposite to the first polarity; and
a back surface battery part including a back surface first polarity layer laminated on a back surface side of the substrate to occlude and release a lithium ion with the first polarity, a back surface solid electrolyte layer laminated on the back surface first polarity layer and including an inorganic solid electrolyte having lithium-ion conductivity, and a back surface second polarity layer laminated on the back surface solid electrolyte layer to occlude and release a lithium ion with the second polarity.

17. The battery structure of a lithium-ion rechargeable battery according to claim 16, wherein the front surface first polarity layer and the back surface first polarity layer are configured with a same material, the front surface solid electrolyte layer and the back surface solid electrolyte layer are configured with a same material, and the front surface second polarity layer and the back surface second polarity layer are configured with a same material.

18. The battery structure of a lithium-ion rechargeable battery according to claim 16, further comprising:
a connection member that electrically connects the front surface second polarity layer of the front surface battery portion and the back surface second polarity layer of the back surface battery portion.

19. The battery structure of a lithium-ion rechargeable battery according to claim 17, further comprising:
a connection member that electrically connects the front surface second polarity layer of the front surface battery portion and the back surface second polarity layer of the back surface battery portion.

20. A method for producing a lithium-ion rechargeable battery, comprising:
a process of depositing, on a front surface of a substrate, a front surface first polarity layer that occludes and releases a lithium ion with a first polarity and depositing, on a back surface of the substrate, a back surface first polarity layer that occludes and releases a lithium ion with the first polarity;
a process of depositing, on the front surface first polarity layer, a front surface solid electrolyte layer that contains an inorganic solid electrolyte having lithium-ion conductivity and depositing, on the back surface first polarity layer, a back surface solid electrolyte layer that contains an inorganic solid electrolyte having lithium-ion conductivity; and
a process of depositing, on the front surface solid electrolyte layer, a front surface second polarity layer that occludes and releases a lithium ion with a second polarity, which is opposite to the first polarity, and depositing, on the back surface solid electrolyte layer, a back surface second polarity layer that occludes and releases a lithium ion with the second polarity.
